(19) United States
(12) Patent Application Publication
(10) Pub. No.: US 2008/0162805 A1
(43) Pub. Date: Jul. 3, 2008

(54) Method and Apparatus for Using Non-Addressable Memories of a Computer System

(76) Inventors: Randall S. Springfield, Chapel Hill, NC (US); Daryl Cromer, Cary, NC (US); Howard Locker, Cary, NC (US); Rod D. Waltermann, Rougemont, NC (US)

Correspondence Address: DILLION & YUDELL LLP, 8911 N. CAPITAL OF TEXAS HWY, SUITE 2110, AUSTIN, TX, 78759, US

(21) Appl. No.: 11/619,293

(22) Filed: Jan. 3, 2007

(51) Int. Cl. G06F 12/08

(52) U.S. Cl. 711/113; 711/E12.019

(57) ABSTRACT

A method for using non-addressable memory of a computer system is disclosed. Any system memory above an addressable memory limit of a computer system (i.e., non-addressable memory) is initially converted to a disk cache by a hypervisor. In response to a read request, the hypervisor intercepts the read request, and then sends the data for the read request from the disk cache to a read requestor if the data for the read request is available in the disk cache. In response to a write request, the hypervisor intercepts the write request, and then writes the data for the write request to the disk cache and updating corresponding disk cache tables.

### BACKGROUND OF THE INVENTION

1. Technical Field

The present invention relates to computer systems in general, and, in particular, to a method and apparatus for maximizing memory utilizations in computer systems. Still more particularly, the present invention relates to a method and apparatus for using non-addressable memories of a computer system.

2. Description of Related Art

Generally speaking, computer systems have a variety of configurable aspects that can be customized to suit different users' individual needs. Examples of such configurable aspects within a computer system include the amount of system memory and the type of device drivers. A device driver is a piece of software that enables various operations of a peripheral device, such as a graphics card, installed within a computer system. One device driver may permit the computer system to function better with a specific peripheral device than another device driver or a different version of the same device driver.

Current software, including operating systems and application programs, tends to demand mass quantities of system memory. As such, more system memory in a computer system will typically lead to a better performance. However, because the combination of the Intel® x86 processor design and the Windows® operating system are based on a maximum addressing scheme, only a portion of the total system memory installed within a computer system can be addressed by software applications executing within the computer system having such the above-mentioned combination. For example, the current 32-bit Windows® operating system can only address up to four gigabytes of system memory, so even if additional system memory is added above four gigabyte, the performance of the computer system will not be improved. Another example is the current Intel® 32-bit memory controller architecture that reserves memory addresses above 3.1 gigabyte for input/output registers such as peripheral component interconnect (PCI) express, so even if additional system memory is added above 3.1 gigabyte, the performance of the computer system will not be improved.

Consequently, it would be desirable to provide an improved method and apparatus for maximizing memory utilization in a computer system that has its memory addressing scheme limited by the current architecture attributed to the processor design, memory controller design and/or the operating system.

### SUMMARY OF THE INVENTION

In accordance with a preferred embodiment of the present invention, any system memory above an addressable memory limit of a computer system is converted to a disk cache by a hypervisor. In response to a read request, the hypervisor intercepts the read request, and then sends the data for the read request from the disk cache to a read requestor if the data for the read request is available in the disk cache. In response to a write request, the hypervisor intercepts the write request, and then writes the data for the write request to the disk cache and updating corresponding disk cache tables.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer system in which a preferred embodiment of the present invention is incorporated;

FIG. 2 is a high-level logic flow diagram of a method for using non-addressable memories of a computer system during a read operation, in accordance with a preferred embodiment of the present invention; and

FIG. 3 is a high-level logic flow diagram of a method for using non-addressable memories of a computer system during a write operation, in accordance with a preferred embodiment of the present invention.

### DETAILED DESCRIPTION OF A PREFERRED EMBODIMENT

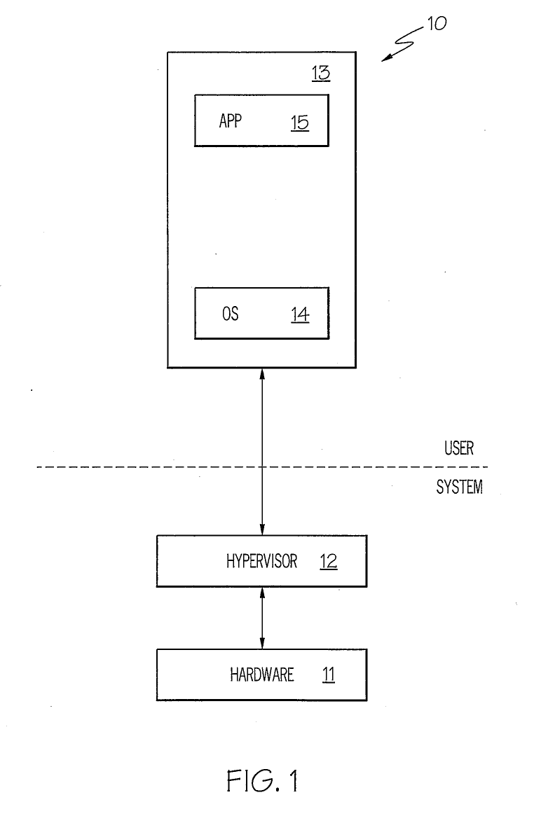

Referring now to the drawings and in particular to FIG. 1, there is depicted a block diagram of a computer system in which a preferred embodiment of the present invention is incorporated. As shown, a computer system 10 includes a hardware structure 11, a hypervisor or virtual machine manager (VMM) 12 and a virtual machine 13. Hypervisor 12 controls all communications to virtual machine 13. In addition, hypervisor 12 can directly communicate with hardware structure 11. Hardware structure 11 includes such known structures as processors, registers, memory management units, memory devices, input/output devices, etc.

An operating system and multiple application programs can be executed concurrently within virtual machine 13. For example, an operating system 14 and an application program 15 are executed within virtual machine 13.

Operating system 14 can be Windows® operating system manufactured by the Microsoft Corporation. Similarly, the underlying processor emulated by virtual machine 13 can be a Pentium® processor manufactured by the Intel Corporation.

Virtual machine 13, which includes its operating system and associated application programs, operates at a user-level. When hypervisor 12 uses direct execution, hypervisor 12 is set to a so-called user-mode (i.e., with reduced privileges) so that virtual machine 13 cannot directly access the various privileged registers that control the operation of hardware structure 11. Rather, all privileged instructions will be trapped into hypervisor 12.

In accordance with a preferred embodiment of the present invention, any system memory above the addressable memory limit (i.e., non-addressable memory) is converted to a disk cache during system boot, and hypervisor 12 is utilized to manage the disk cache. For example, the addressable memory limit of a computer system having a 32-bit Windows® operating system is four gigabyte, and any system memory above four gigabyte present within the computer system is converted to a disk cache during system boot. The conversion of a portion of the system memory to a disk cache can be preformed via an appropriate disk cache device driver.

Because memory-to-memory transfers are faster than device accesses, such as hard disk accesses, each time an operating system attempts to address a device, hypervisor 12 traps such access and handles any data transfers by effectively moving the data between the system memory above the addressable memory limit and the operating system's addressable memory range. This will speed up a computer system as well as meeting the requirements for the lower memory of the computer system.

Another usage for the system memory above the addressable memory limit of a computer system is to hold a swap file. Since the swap file is utilized to save data when the system memory is overloaded, using the system memory above the addressable memory limit to hold a swap file can speed up data transfers and can increase the performance of the computer system. Yet another usage for the system memory above the addressable memory limit of a computer system is to allow hypervisor 12 to aggregate hard disk access across partitions (for a computer system having multiple operating systems) to gain efficiencies in system memory utilization as well as speed in eliminating redundant storage access.

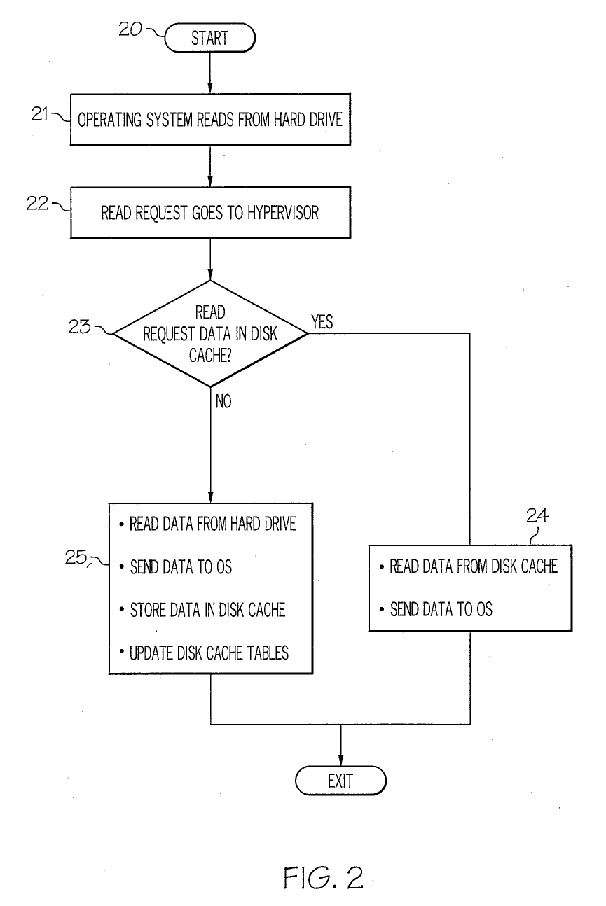

With reference now to FIG. 2, there is depicted a high-level logic flow diagram of a method for using non-addressable memories in a computer system during a read operation, in accordance with a preferred embodiment of the present invention. Starting at block 20, in response to a read operation, an operating system attempts to read the data corresponding to the read operation from a hard drive by sending a read request to the hard drive, as shown in block 21. The read request is then intercepted by a hypervisor, such as hypervisor 12 from FIG. 1, as depicted in block 22. A determination is then made by the hypervisor to check whether or not the data for the read request is stored in a disk cache formed by any system memory above the addressable memory limit of the computer system, as shown in block 23. If the data for the read request is stored in the disk cache, then the data for the read request is read from the disk cache, and the data for the read request is subsequently sent to the operating system, as shown in block 24. Otherwise, if the data for the read request is not stored in the disk cache, the data for the read request is read from a hard drive, the data for the read request is sent from the hard drive to the operating system as well as to the disk cache, and the disk cache tables are updated, as depicted in block 25.

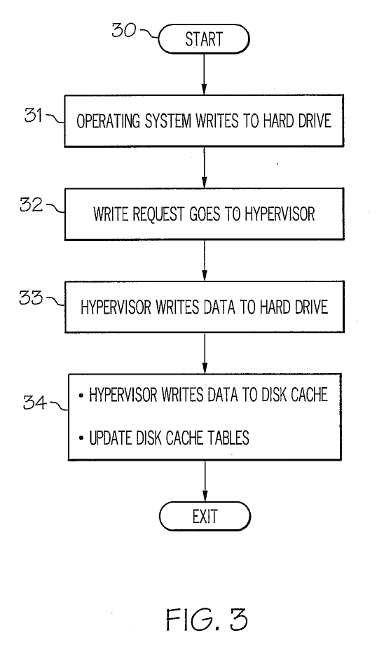

Referring now to FIG. 3, there is depicted a high-level logic flow diagram of a method for using non-addressable memories in a computer system during a write operation, in accordance with a preferred embodiment of the present invention. Starting at block 30, in response to a write operation, an operating system attempts to write the data to a hard drive, as shown in block 31. The write request is then intercepted by the hypervisor, as depicted in block 32. The hypervisor subsequently writes the data for the write request to the hard drive, as shown in block 33. The hypervisor also writes the data for the write request to the disk cache, and the disk cache tables are updated, as depicted in block 34.

As has been described, the present invention provides a method and apparatus for using non-addressable memories in a computer system.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for using non-addressable memories in a computer system, said method comprising:
converting any system memory above an addressable memory limit of said computer system to a disk cache by a hypervisor;
in response to a read request,
intercepting said read request by said hypervisor;
sending data for said read request from said disk cache by said hypervisor to a read requestor if said data for said read request is available in said disk cache; and
in response to a write request,
intercepting said write request by said hypervisor;
writing data for said write request to said disk cache and updating corresponding disk cache tables by said hypervisor.

2. The method of claim 1, wherein said sending further includes sending data for said read request from a hard drive by said hypervisor to said read requestor if said data for said read request is not available in said disk cache.

3. The method of claim 2, wherein said sending further includes sending data for said read request from said hard drive to said disk cache, and updating corresponding disk cache tables by said hypervisor.

4. The method of claim 1, wherein said writing further includes writing data for said write request to said hard drive by said hypervisor.

5. The method of claim 1, wherein said addressable memory limit is less than four gigabyte.

6. A computer usable medium having a computer program product for using non-addressable memories in a computer system, said computer usable medium comprising:
program code means for converting any system memory above an addressable memory limit of said computer system to a disk cache by a hypervisor;
in response to a read request,
program code means for intercepting said read request by said hypervisor;
program code means for sending data for said read request from said disk cache by said hypervisor to a read requestor if said data for said read request is available in said disk cache; and
in response to a write request,
program code means for intercepting said write request by said hypervisor;
program code means for writing data for said write request to said disk cache and updating corresponding disk cache tables by said hypervisor.

7. The computer usable medium of claim 6, wherein said program code means for sending further includes program code means for sending data for said read request from a hard drive by said hypervisor to said read requestor if said data for said read request is not available in said disk cache.

8. The computer usable medium of claim 7, wherein said program code means for sending further includes program code means for sending data for said read request from said hard drive to said disk cache, and updating corresponding disk cache tables by said hypervisor.

9. The computer usable medium of claim 6, wherein said program code means for writing further includes program code means for writing data for said write request to said hard drive by said hypervisor.

10. The computer usable medium of claim 6, wherein said addressable memory limit is less than four gigabyte.

11. A computer capable of using non-addressable memories, said computer comprising:
a hypervisor for converting any system memory above an addressable memory limit of said computer to a disk cache;
in response to a read request,
means for intercepting said read request by said hypervisor;
means for sending data for said read request from said disk cache by said hypervisor to a read requestor if said data for said read request is available in said disk cache; and ‘in response to a write request,
means for intercepting said write request by said hypervisor;
means for writing data for said write request to said disk cache and updating corresponding disk cache tables by said hypervisor.

12. The computer of claim 11, wherein said means for sending further includes means for sending data for said read request from a hard drive by said hypervisor to said read requestor if said data for said read request is not available in said disk cache.

13. The computer of claim 12, wherein said means for sending further includes means for sending data for said read request from said hard drive to said disk cache, and updating corresponding disk cache tables by said hypervisor.

14. The computer of claim 11, wherein said means for writing further includes means for writing data for said write request to said hard drive by said hypervisor.

15. The computer of claim 11, wherein said addressable memory limit is less than four gigabyte.
